(19) United States
(12) Patent Application Publication
(10) Pub. No.: US 2026/0035218 A1
(43) Pub. Date: Feb. 5, 2026

(54) AUTOMATIC RESETTING MECHANISM FOR WINCH ENGAGING-DISENGAGING SWITCH

(71) Applicant: Ningbo Lianda Winch Co., Ltd., Ningbo (CN)

(72) Inventor: Xiaojun CUI, Ningbo (CN)

(73) Assignee: Ningbo Lianda Winch Co., Ltd., Ningbo (CN)

(21) Appl. No.: 18/915,434

(22) Filed: Oct. 15, 2024

(30) Foreign Application Priority Data
Aug. 1, 2024 (CN) 202411047106.7

(51) Int. Cl. B66D 1/22

(52) U.S. Cl. CPC B66D 1/225

(57) ABSTRACT

An automatic resetting mechanism for a winch engaging-disengaging switch includes a winch bracket, a motor drive assembly, a gear box, a drive shaft, a planetary gear set, and an engaging-disengaging assembly. At least one gear ring locking portion is disposed circumferentially on an outer circumferential wall of a gear ring of the planetary gear set. The engaging-disengaging assembly includes an engaging-disengaging seat, an engaging-disengaging shaft, and an engaging-disengaging toggle sheet. The engaging-disengaging seat is fixed on the gear box. A positioning step is disposed on the engaging-disengaging seat. The engaging-disengaging shaft is penetrated into the engaging-disengaging seat. An engaging-disengaging pin is disposed on a sidewall of the engaging-disengaging shaft. The engaging-disengaging pin is abutted against the positioning step. A resetting drive component in transmission cooperation with the engaging-disengaging toggle sheet is disposed on a planetary gear side plate of the planetary gear set.

### CROSS REFERENCE TO THE RELATED APPLICATIONS

This application is based upon and claims priority to Chinese Patent Application No. 202411047106.7, filed on Aug. 1, 2024, the entire contents of which are incorporated herein by reference.

### TECHNICAL FIELD

The present disclosure relates to the field of winch technologies and in particular to an automatic resetting mechanism for a winch engaging-disengaging switch.

### BACKGROUND

A winch is a traction device, for example, a vehicle winch is used to carry out self rescue or rescue in a harsh environment. Among the existing winches, the Chinese invention patent (the publication number CN206172856U) provides an electric winch, which includes a winch bracket, a motor housing, a motor, a rotary shaft, a winding drum, a gear box, a planetary gear assembly, and an engaging-disengaging assembly. The existing engaging-disengaging assembly is in the form of an engaging-disengaging handle, which is manually rotated to realize engagement and disengagement between a winding drum and a planetary gear.

When the above structure is used, a user firstly rotates the engaging-disengaging handle to separate the winding drum and the planetary gear to help pull out a cable and fix it on a designated position and then returns to the winch and rotates the engaging-disengaging handle again to engage the winding drum with the planetary gear, so as to make the winch run normally. In the above rotation resetting method, the user needs to return to the winch to perform manual rotation resetting. When the user is far away from the position of fixing the cable or there is an obstacle between the user and the position, it is inconvenient for the user to go back and forth, affecting the user experiences.

### SUMMARY

The present disclosure aims to solve the problem of inconvenient operations resulting from manually toggling a switch of an engaging-disengaging winch back to an engaged state. In order to address the defects in the prior arts, the present disclosure provides an automatic resetting mechanism for a winch engaging-disengaging switch, where a motor drive assembly is rotated to automatically toggle back an engaging-disengaging assembly, without going back to the winch for manually toggling back the engaging-disengaging assembly, thereby bringing conveniences to use, saving time and labor, and greatly improving the use experiences.

For the objects of the present disclosure, the following technical solution will be implemented.

There is provided an automatic resetting mechanism for a winch engaging-disengaging switch, which includes a winch bracket, a motor drive assembly, a gear box, a drive shaft, a planetary gear set and an engaging-disengaging assembly. The motor drive assembly and the gear box are respectively disposed at left and right sides of the winch bracket. The planetary gear set is mounted inside the gear box. An end of the drive shaft is connected with the motor drive assembly, and the motor drive assembly is used to drive the rotation of the drive shaft. The other end of the drive shaft runs through the winch bracket to be in transmission connection with the planetary gear set. At least one gear ring locking portion is disposed circumferentially on an outer circumferential wall of a gear ring of the planetary gear set. The engaging-disengaging assembly includes an engaging-disengaging seat, an engaging-disengaging shaft and an engaging-disengaging toggle sheet. The engaging-disengaging seat is fixed on the gear box. A positioning step is disposed on the engaging-disengaging seat. The engaging-disengaging shaft is penetrated into the engaging-disengaging seat along a radial direction of the drive shaft and rotatably connected with the engaging-disengaging seat. An engaging-disengaging pin protruding along a radial direction of the engaging-disengaging shaft is disposed on a sidewall of the engaging-disengaging shaft. The engaging-disengaging pin is abutted against the positioning step. The engaging-disengaging shaft is rotated along a trajectory of the positioning step through the engaging-disengaging pin such that the engaging-disengaging shaft can be moved axially. In a case of engagement, an inner end of the engaging-disengaging shaft is inserted into the corresponding gear ring locking portion. An elastic connection piece is disposed between the engaging-disengaging shaft and the engaging-disengaging seat and the elastic connection piece has a tendency of moving the engaging-disengaging shaft radially toward the gear ring. The engaging-disengaging toggle sheet is mounted on the engaging-disengaging shaft. An end of the engaging-disengaging toggle sheet protrudes out of the engaging-disengaging shaft along the radial direction of the engaging-disengaging shaft. A resetting drive component in transmission cooperation with the engaging-disengaging toggle sheet is disposed on a planetary gear side plate of the planetary gear set. The resetting drive component is used to rotate the engaging-disengaging toggle sheet such that the engaging-disengaging shaft can be slid downward along the positioning step and finally inserted into the corresponding gear ring locking portion by the elastic connection piece. This mechanism is rotated by the motor drive assembly to drive the planetary gear set, and the resetting drive component on the planetary gear set automatically toggles back the engaging-disengaging assembly to automatically insert the engaging-disengaging shaft on the engaging-disengaging assembly into the corresponding gear ring locking portion of the gear ring of the planetary gear set and change an idle state of the planetary gear set to a normal running state. In this way, the user does not need to go back to the winch and manually toggle back the engaging-disengaging assembly, bringing much convenience to use, saving time and labor, and improving the user experiences.

Preferably, the resetting drive component includes a resetting push piece connected to the planetary gear side plate, and the resetting push piece is in transmission cooperation with the engaging-disengaging toggle sheet. The resetting push piece abuts against the engaging-disengaging toggle sheet to rotate the engaging-disengaging toggle sheet, thereby realizing the rotation of the engaging-disengaging shaft.

Preferably, the resetting drive component includes a resetting push piece and a resetting clastic piece. The resetting push piece is rotatably connected on the planetary gear side plate. A radial inner end of the resetting push piece is connected with one end of the resetting elastic piece, and the other end of the resetting elastic piece is fixedly connected on the planetary gear side plate. The radial outer end of the resetting push piece is in transmission cooperation with the engaging-disengaging toggle sheet. The resetting elastic piece can rotationally reset the slipping resetting push piece during reverse rotation. In a case of engagement, the resetting push piece can rotate along with the planetary gear side plate to abut against the engaging-disengaging toggle sheet, so as to realize synchronous movement of the engaging-disengaging toggle sheet and the engaging-disengaging shaft. Finally, the engaging-disengaging shaft is in insertion cooperation with the gear ring locking portion. Under the action of the resetting elastic piece, positioning is performed with the resetting push piece, and the resetting push piece is rotated synchronously under the action of the rotation of the planetary gear side plate such that the end of the resetting push piece can be in transmission cooperation with the engaging-disengaging toggle sheet, so as to realize the rotation of the engaging-disengaging toggle sheet and further achieve the rotation of the engaging-disengaging shaft. Furthermore, the resetting clastic piece can also ensure the unidirectional movement of the resetting push piece so as to further ensure the transmission stability.

Preferably, a limiting column is disposed on the planetary gear side plate and located at a radial inner side of the resetting push piece. A limiting recess in limiting cooperation with the limiting column is disposed on the resetting push piece to achieve rotational limitation for the resetting push piece. The cooperation of the limiting column and the limiting recess further guarantees a rotational angle of the resetting push piece and realizes the rotational limitation, further improving the accuracy and stability in the rotation process.

Preferably, a gear ring positioning sleeve is mounted inside the gear box. A gear ring positioning annular groove is disposed circumferentially on an inner circumferential wall of the gear ring positioning sleeve. The gear ring is rotatably connected inside the gear ring positioning annular groove, and positioned along the axial direction of the drive shaft inside the gear ring positioning annular groove. A penetration insertion hole for the inner end of the engaging-disengaging shaft to penetrate through is disposed at the engaging-disengaging shaft on the gear ring positioning sleeve. An active opening for rotation of the engaging-disengaging toggle sheet is disposed at a side of the penetration insertion hole close to the resetting drive component. The gear ring positioning annular groove on the gear ring positioning sleeve can help to axially limit the gear ring to prevent the axial movement of the gear ring during the rotation process, ensuring the transmission accuracy. Furthermore, the penetration insertion hole helps the engaging-disengaging shaft to penetrate into the gear ring locking portion. With the active opening, a rotation space can be provided for the engaging-disengaging toggle sheet to prevent interference between the rotating engaging-disengaging toggle sheet and the gear ring positioning sleeve.

Preferably, a first limiting portion and a second limiting portion for limiting the engaging-disengaging pins from sliding are respectively disposed at both ends of each positioning step. Each of the positioning steps includes a horizontal disengaging segment, and a horizontal engaging segment which are from shallow to deep. In a case of disengagement, the engaging-disengaging pins are located in the disengaging segments and limitedly abutted against the first limiting portions. In this case, the engaging-disengaging shaft is disengaged from the gear ring locking portions. In a case of engagement, the engaging-disengaging pins are located in the engaging segments and limitedly abutted against the second limiting portions. In this case, the engaging-disengaging shaft is inserted into and abutted in the gear ring locking portion. The first limiting portions and the second limiting portions can realize rotation limitation. With the horizontal disengaging segments and the horizontal engaging segments, the positioning stability and accuracy can be further guaranteed.

Preferably, an inwardly-recessed first step is disposed inside the engaging-disengaging seat; an inwardly-recessed second step is disposed on the engaging-disengaging shaft inside the engaging-disengaging seat; the elastic connection piece is sleeved on the second step; one end of the elastic connection piece is abutted against a first step surface of the first step, and the other end of the elastic connection piece is abutted against a second step surface of the second step. With the first step and the second step, the elastic connection piece can be easily mounted. Further, it can be guaranteed that the engaging-disengaging shaft always has a tendency of moving inward under the action of the elastic connection piece. In the engaging and disengaging process, it is further guaranteed that the engaging-disengaging shaft can be accurately inserted into the corresponding gear ring locking portion.

Preferably, a lower end of the engaging-disengaging shaft penetrates through the engaging-disengaging seat and is integrally provided with an inwardly-recessed engaging-disengaging shaft fixing segment; a fixing step is formed between the engaging-disengaging shaft fixing segment and the inner end of the engaging-disengaging shaft; an annular clamping groove is disposed on the engaging-disengaging shaft fixing segment and a circlip is disposed in the annular clamping groove. The engaging-disengaging toggle sheet is sleeved on the engaging-disengaging shaft fixing segment, and limited between the fixing step and the circlip. The circlip can further limit the engaging-disengaging toggle sheet and prevent the engaging-disengaging toggle sheet from falling down while ensuring radial movement. Moreover, the engaging-disengaging shaft fixing segment can guarantee the engaging-disengaging toggle sheet and the engaging-disengaging shaft rotate synchronously.

Preferably, an insertion shaft segment is integrally disposed on an inner end of the engaging-disengaging shaft fixing segment. An inwardly-recessed insertion step is formed between the insertion shaft segment and the inner end of the engaging-disengaging shaft. In a case of locking, the insertion shaft segment is inserted into the gear ring locking portion, and an insertion step surface of the insertion step is abutted against an outer circumferential wall of the gear ring. In cooperation with the gear ring locking portions, the stability and connectivity of the insertion shaft segment inserted is guaranteed.

Preferably, an engaging-disengaging switching handle is fixedly connected at an outer end of the engaging-disengaging shaft, and the engaging-disengaging switching handle is located outside the gear box. The engaging-disengaging switching handle further improves the entire aesthetics and meanwhile, the engaging-disengaging switching handle can be more easily rotated.

In conclusion, the present disclosure has the following advantages: this mechanism is rotated by the motor drive assembly to drive the planetary gear set, and the resetting drive component on the planetary gear set automatically toggles back the engaging-disengaging assembly to automatically insert the engaging-disengaging shaft on the engaging-disengaging assembly into the corresponding gear ring locking portion of the gear ring of the planetary gear set and change an idle state of the planetary gear set to a normal running state. In this way, the user does not need to go back to the winch and manually toggle back the engaging-disengaging assembly, bringing much convenience to use, saving time and labor, and improving the user experiences.

### BRIEF DESCRIPTION OF THE DRAWINGS

FIG. 1 is a structural schematic diagram illustrating an automatic resetting mechanism for a winch engaging-disengaging switch according to the present disclosure.

FIG. 2 is a structural schematic diagram illustrating an engaging-disengaging assembly and a resetting drive component according to the present disclosure.

FIG. 3 is a sectional structural diagram illustrating the engaging-disengaging assembly and the resetting drive component according to the present disclosure.

FIG. 4 is an exploded view illustrating the engaging-disengaging assembly according to the present disclosure.

### Numerals of the Drawings are Described Below:

1. winch bracket, 2. motor drive assembly, 3. gear box, 30. gear ring positioning sleeve, 301. gear ring positioning annular groove, 302. penetration insertion hole, 303. active opening, 4. drive shaft, 5. first planetary gear set, 6. second planetary gear set, 61. gear ring, 611. gear ring locking portion, 62. planetary gear side plate, 7. engaging-disengaging assembly, 701. first limiting portion, 702. second limiting portion, 703. disengaging segment, 7.4 transitional segment, 705. engaging segment, 71. engaging-disengaging seat, 711. first step, 712. first step surface, 72. engaging-disengaging shaft, 720. engaging-disengaging pin, 721. second step, 722. second step surface, 723. engaging-disengaging shaft fixing segment, 724. fixing step, 73. engaging-disengaging toggle sheet, 74. elastic connection piece, 75. circlip, 76. insertion shaft segment, 77. insertion step, 771. insertion step surface, 78. engaging-disengaging switching handle, 8. resetting drive component, 81. resetting push piece, 811. limiting recess, 82. resetting elastic piece, 83. limiting column, and 9. third planetary gear set.

### DETAILED DESCRIPTION OF THE EMBODIMENTS

In order to make the above objects, features and advantages of the present disclosure clearer and more intelligible, the present disclosure will be further detailed below in combination with drawings and specific embodiments.

### Embodiment 1

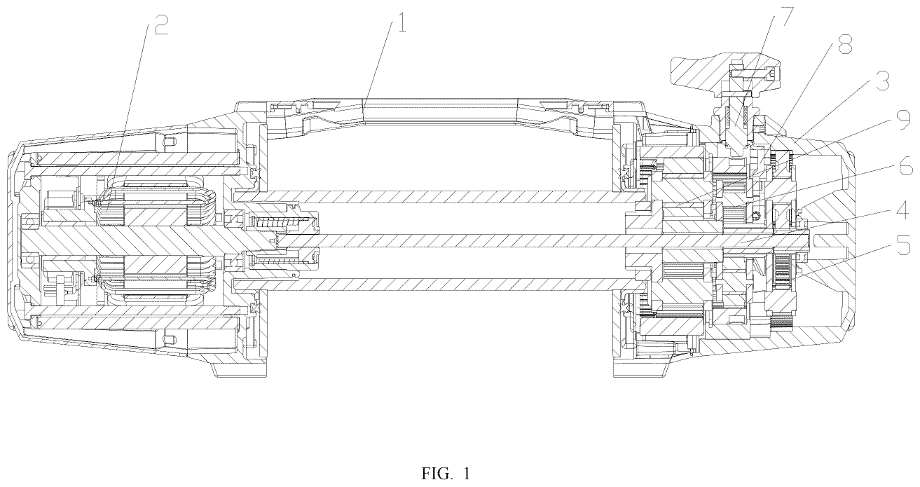

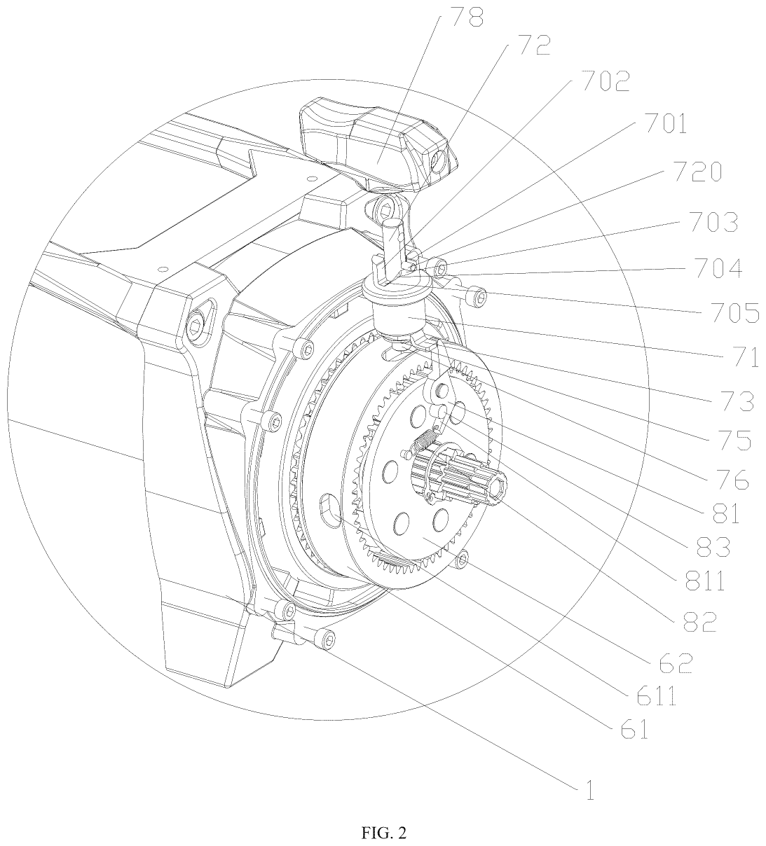

As shown in FIGS. 1 to 4, there is provided an automatic resetting mechanism for a winch engaging-disengaging switch, which includes a winch bracket 1, a motor drive assembly 2, a gear box 3, a drive shaft 4, a planetary gear set and an engaging-disengaging assembly 7. In this embodiment, the planetary gear set includes a first planetary gear set 5, a second planetary gear set 6 and a third planetary gear set 9. The motor drive assembly 2 and the gear box 3 are respectively disposed at left and right sides of the winch bracket 1 (along an axial direction of the drive shaft 4). The third planetary gear set 9, the second planetary gear set 6 and the first planetary gear set 5 are mounted sequentially inside the gear box 3 from left to right (along the axial direction of the drive shaft 4), and transmission connection is carried out among the third planetary gear set 9, the second planetary gear set 6 and the first planetary gear set 5. A left end of the drive shaft 4 is connected with the motor drive assembly 2 such that the motor drive assembly 2 can bring the rotation of the drive shaft 4. The motor drive assembly 2 is a drive structure of an existing conventional winch, which will not be described redundantly herein. A right end of the drive shaft 4 sequentially penetrates through the winch bracket 1, the third planetary gear set 9 and the second planetary gear set 6 and is connected in a transmission way with a central gear of the first planetary gear set 5. A plurality of equally-spaced gear ring locking portions 611 are disposed circumferentially on an outer circumferential wall of a gear ring 61 of the second planetary gear set 6, and the gear ring locking portions 611 are insertion grooves radially recessed inwardly. The engaging-disengaging assembly 7 includes an engaging-disengaging seat 71, an engaging-disengaging shaft 72 and an engaging-disengaging toggle sheet 73. The engaging-disengaging seat 71 is fixedly connected at a top of the gear box 3 by using screws. The engaging-disengaging seat 71 is vertically disposed (along a radial direction of the drive shaft 4). A positioning step recessed downwardly (along the radial direction of the drive shaft 4) is disposed on a top surface of a circumferential wall of the engaging-disengaging seat 71. In this embodiment, two positioning steps are disposed and distributed in central symmetry. The engaging-disengaging shaft 72 is penetrated into the engaging-disengaging seat 71 along the radial direction of the drive shaft 4 and rotatably connected with the engaging-disengaging seat 71. An engaging-disengaging pin 720 protruding along a radial direction of the engaging-disengaging shaft 72 is disposed on a sidewall of the engaging-disengaging shaft 72. In this embodiment, two engaging-disengaging pins 720 are disposed as protruding symmetrically and the two engaging-disengaging pins 720 are respectively abutted against the two positioning steps. The engaging-disengaging shaft 72 is rotated along a trajectory of the positioning steps through the engaging-disengaging pins 720 such that the engaging-disengaging shaft 72 can be moved up and down (along the radial direction of the drive shaft 4). In a case of engagement, a lower end of the engaging-disengaging shaft 72 (an inner end along the radial direction of the drive shaft 4) is inserted into the corresponding gear ring locking portion 611. An elastic connection piece 74 is disposed between the engaging-disengaging shaft 72 and the engaging-disengaging seat 71, and the elastic connection piece is a connection spring which has a tendency of moving the engaging-disengaging shaft 72 downward (along the radial direction of the drive shaft 4). The engaging-disengaging toggle sheet 73 is fixedly connected on the engaging-disengaging shaft 72 and located below the engaging-disengaging seat 71 (at inner side along the radial direction of the drive shaft 4). An end of the engaging-disengaging toggle sheet 73 protrudes out of the engaging-disengaging shaft 72 along the radial direction of the engaging-disengaging shaft 72.

A resetting drive component 8 in transmission cooperation with the engaging-disengaging toggle sheet 73 is disposed on a planetary gear side plate 62 at the right side of the second planetary gear set 6. The resetting drive component 8 is used to rotate the engaging-disengaging toggle sheet 73 such that the engaging-disengaging shaft 72 can be slid downward along the positioning steps and finally inserted into the corresponding gear ring locking portion 611. This mechanism is rotated by the motor drive assembly 2 to drive the second planetary gear set 6, and the resetting drive component 8 on the second planetary gear set automatically toggles back the engaging-disengaging assembly 7 to automatically insert the engaging-disengaging shaft 72 on the engaging-disengaging assembly 7 into the corresponding gear ring locking portion 611 of the gear ring 61 of the second planetary gear set 6 and change an idle state of the second planetary gear set 6 to a normal running state. In this way, the user does not need to go back to the winch and manually toggle back the engaging-disengaging assembly 7, bringing much convenience to use, saving time and labor, and improving the user experiences.

As shown in FIGS. 1 to 3, the resetting drive component 8 includes a resetting push piece 81 and a resetting elastic piece 82; the resetting push piece 81 is a resetting pawl plate and the resetting elastic piece 82 is a resetting spring. The resetting push piece 81 is rotatably connected on a right side surface of the planetary gear side plate 62, and the rotation direction of the resetting push piece 81 is the same as that of the planetary gear side plate 62. An upper end (radial outer end) of the resetting push piece 81 is exposed beyond the planetary gear side plate 62 and a lower end (radial inner end) of the resetting push piece 81 is connected with an end of the resetting elastic piece 82. Further, the other end of the resetting elastic piece 82 is fixedly connected to the planetary gear side plate 62. The upper end (radial outer end) of the resetting push piece 81 is in transmission cooperation with the engaging-disengaging toggle sheet 73. The resetting elastic piece 82 can rotationally reset the slipping resetting push piece 81 during reverse rotation. The resetting push piece 81 can rotate along with the planetary gear side plate 62 to abut against the engaging-disengaging toggle sheet 73 and thus enable the engaging-disengaging toggle sheet 73 to bring the engaging-disengaging shaft 72 to be movably inserted into the gear ring locking portion 611 along the radial direction of the drive shaft 4. Under the action of the resetting elastic piece 82, positioning is performed with the resetting push piece 81, and the resetting push piece 81 is rotated synchronously under the action of the rotation of the planetary gear side plate 62 such that the end of the resetting push piece 81 can be in transmission cooperation with the engaging-disengaging toggle sheet 73, so as to realize the rotation of the engaging-disengaging toggle sheet 73 and further achieve the rotation of the engaging-disengaging shaft 72. Further, the resetting elastic piece 82 can also ensure the unidirectional movement of the resetting push piece 81 so as to further ensure the transmission stability. A limiting column 83 is disposed on the right side surface of the planetary gear side plate 62 and located at a radial inner side of the resetting push piece 81. A limiting recess 811 in limiting cooperation with the limiting column 83 is disposed on the resetting push piece 81. The limiting column 83 can achieve the blocking and limiting effect. When the resetting push piece 81 impacts the engaging-disengaging toggle sheet 73, the resetting push piece 81 may receive a reactive force and reversely rotate under the reactive force. With the limiting column 83, the resetting push piece 81 can be limited to prevent reverse rotation of the resetting push piece 81, thus realizing limited rotation of the resetting push piece 81. The cooperation of the limiting column 83 and the limiting recess 811 further guarantees the limited rotation of the resetting push piece 81 and therefore the resetting push piece 81 can rotate the engaging-disengaging toggle sheet 73 after being limited, so as to improve the accuracy and stability of the rotation process.

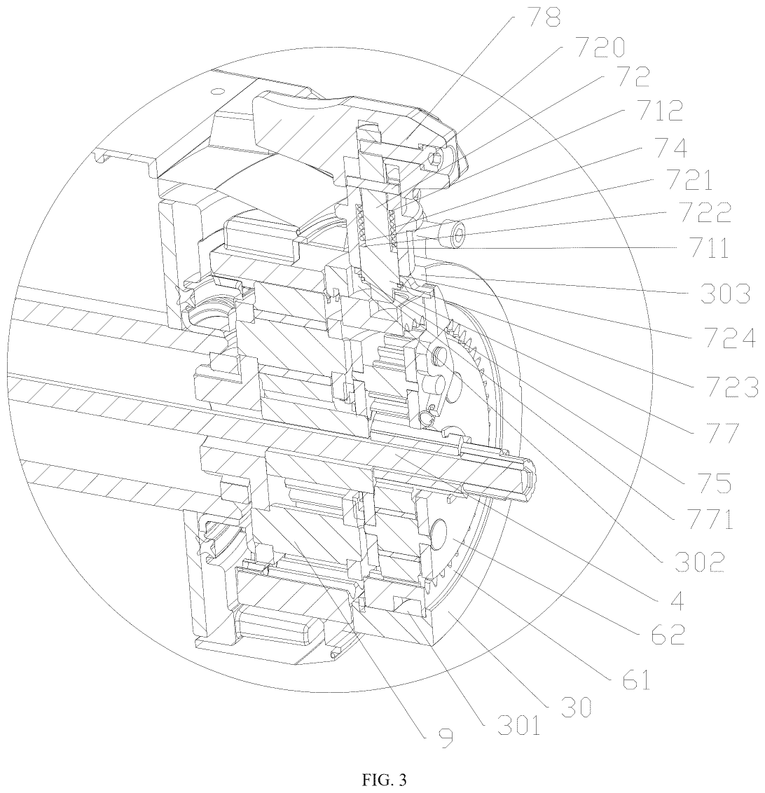

As shown in FIG. 3, a gear ring positioning sleeve 30 is mounted inside the gear box 3. A gear ring positioning annular groove 301 is disposed circumferentially on an inner circumferential wall of the gear ring positioning sleeve 30. The gear ring 61 is rotatably connected inside the gear ring positioning annular groove 301, and positioned along the axial direction of the drive shaft 4 inside the gear ring positioning annular groove 301. In addition to realizing rotatable connection, the gear ring positioning annular groove 301 can help to axially limit the gear ring 61 to prevent the axial movement of the gear ring 61 during the rotation process, ensuring the transmission accuracy of the gear ring 61 and the transmission stability of the planetary gear set. A penetration insertion hole 302 for the inner end of the engaging-disengaging shaft 72 to penetrate through is disposed at the engaging-disengaging shaft 72 on the gear ring positioning sleeve 30. The penetration insertion hole 302 helps the engaging-disengaging shaft 72 to penetrate into the gear ring locking portion 611. An active opening 303 for rotation of the engaging-disengaging toggle sheet 73 is disposed at a side of the penetration insertion hole 302 close to the resetting drive component 8. With the active opening 303, a rotation space can be provided for the engaging-disengaging toggle sheet 73 to prevent interference between the rotating engaging-disengaging toggle sheet 73 and the gear ring positioning sleeve 30, further ensuring normal switching during the engaging and disengaging process.

As shown in FIGS. 1 to 4, a first limiting portion 701 and a second limiting portion 702 for limiting the engaging-disengaging pins 720 from sliding are respectively disposed at both ends of each positioning step. Each of the positioning steps includes a horizontal disengaging segment 703, an inclined transitional segment 704 and a horizontal engaging segment 705 which are from shallow to deep. The first limiting portion 701 and the second limiting portion 702 are upwardly-protruding positioning bosses (along the radial direction of the drive shaft 4). In a case of disengagement, the engaging-disengaging pins 720 are located in the disengaging segments 703 and limitedly abutted against the first limiting portions 701. In this case, the engaging-disengaging shaft 72 is disengaged from the gear ring locking portions 611. In a case of engagement, the engaging-disengaging pins 720 are located in the engaging segments 705 and limitedly abutted against the second limiting portions 702. In this case, the engaging-disengaging shaft 72 is inserted into and abutted in the gear ring locking portion 611. The first limiting portions 701 and the second limiting portions 702 can realize rotation limitation. With the horizontal disengaging segments 703 and the horizontal engaging segments 705, the positioning stability and accuracy can be further guaranteed. In this way, the winch can be accurately put in a disengaged or engaged state.

As shown in FIG. 3, an inwardly-recessed first step 711 is disposed inside the engaging-disengaging seat 71; an inwardly-recessed second step 721 is disposed on the engaging-disengaging shaft 72 inside the engaging-disengaging seat 71; the elastic connection piece 74 is sleeved on the second step 721; one end of the elastic connection piece 74 is abutted against a first step surface 712 of the first step 711, and the other end of the elastic connection piece 74 is abutted against a second step surface 722 of the second step 721. With the first step 711 and the second step 721, the elastic connection piece 74 can be easily mounted. Further, it can be guaranteed that the engaging-disengaging shaft 72 always has a tendency of moving inward radially under the action of the elastic connection piece 74. In the engaging and disengaging process, it is further guaranteed that the engaging-disengaging shaft 72 can be accurately inserted into the corresponding gear ring locking portion 611.

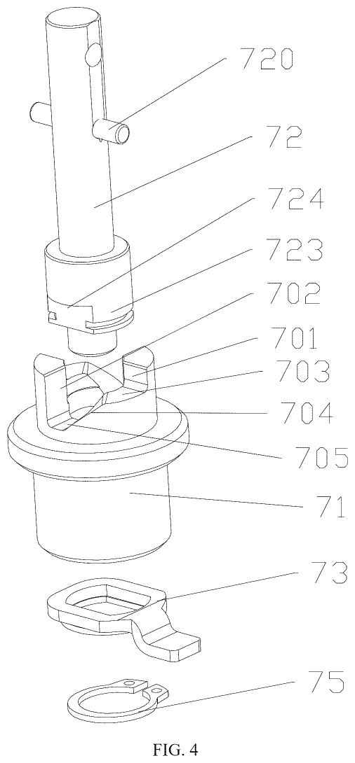

As shown in FIGS. 3 and 4, a lower end of the engaging-disengaging shaft 72 (inner end along the radial direction of the drive shaft 4) penetrates through the engaging-disengaging seat 71 and is integrally provided with an inwardly-recessed engaging-disengaging shaft fixing segment 723; a fixing step 724 is formed between the engaging-disengaging shaft fixing segment 723 and the lower end (inner end at the radial direction of the drive shaft 4) of the engaging-disengaging shaft 72; an annular clamping groove is disposed on the engaging-disengaging shaft fixing segment 723 and a circlip 75 is disposed in the annular clamping groove. The engaging-disengaging toggle sheet 73 is sleeved on the engaging-disengaging shaft fixing segment 723, and limited between the fixing step 724 and the circlip 75. The circlip 75 can further limit the engaging-disengaging toggle sheet 73 and prevent the engaging-disengaging toggle sheet 73 from falling down while ensuring radial movement. Moreover, the engaging-disengaging shaft fixing segment 723 can guarantee the engaging-disengaging toggle sheet 73 and the engaging-disengaging shaft 72 rotate synchronously. An insertion shaft segment 76 is integrally disposed on a lower end (inner end along the radial direction of the drive shaft 4) of the engaging-disengaging shaft fixing segment 723. An inwardly-recessed insertion step 77 is formed between the insertion shaft segment 76 and the lower end of the engaging-disengaging shaft 72 (inner end along the radial direction of the drive shaft 4). In a case of locking, the insertion shaft segment 76 is inserted into the gear ring locking portion 611, and an insertion step surface 771 of the insertion step 77 is abutted against an outer circumferential wall of the gear ring 61. In cooperation with the gear ring locking portions 611, the stability and connectivity of the insertion shaft segment 76 inserted is guaranteed. An engaging-disengaging switching handle 78 is fixedly connected at an outer end of the engaging-disengaging shaft 72, and the engaging-disengaging switching handle 78 is located outside the gear box 3. The engaging-disengaging switching handle 78 further improves the entire aesthetics and meanwhile, the engaging-disengaging switching handle 78 can be more easily rotated.

During use, the engaging-disengaging switching handle 78 on the engaging-disengaging assembly 7 is first rotated counterclockwise to enable the engaging-disengaging switching handle 78 to bring the rotation of the engaging-disengaging shaft 72 and also enable the engaging-disengaging pin 720 on the engaging-disengaging shaft 72 to slide from the engaging segments 705 to the disengaging segments 703 along the positioning steps. During the slide process, due to height difference, the engaging-disengaging shaft 72 is moved up to disengage from the gear ring locking portion 611 on the gear ring 61 of the second planetary gear set 6. Finally, the engaging-disengaging shaft 72 is positioned on the disengagement segments 703 under the limitation of the first limiting portions 701 so as to completely disengage the engaging-disengaging shaft 72 from the gear ring locking portion 611, leaving the gear ring 61 in an idle state. In this case, the planetary gear set cannot transmit power to the winding drum, making the winding drum on the winch idle. Therefore, the user may conveniently pull out the cable from the winch and hang it on the tree or pole on the spot.

After the cable is fixed, the motor drive assembly 2 is rotated clockwise by remote control such that the motor drive assembly 2 can bring the clockwise rotation of the drive shaft 4 and thus the drive shaft 4 can drive the rotation of the first planetary gear set 5. The transmission is conveyed from the first planetary gear set 5 to the planetary gear side plate 62 of the second planetary gear set 6 and hence the resetting push piece 81 on the resetting drive component 8 is rotated in synchronization with the planetary gear side plate 62. An outer end of the resetting push piece 81 abuts against the engaging-disengaging toggle sheet 73 on the engaging-disengaging shaft 72 during the rotation process, and the resetting push piece 81 is fixedly limited by the limiting column 83. In this way, the resetting push piece 81 drives the clockwise rotation of the engaging-disengaging toggle sheet 73 so as to drive the clockwise rotation of the engaging-disengaging shaft 72. Therefore, the engaging-disengaging pins 720 are slid from the disengaging segment 703 to the engaging segment 705 along the positioning steps. During the slide, the engaging-disengaging shaft 72 gradually descends along the positioning steps while the elastic connection piece 74 always provides a downward acting force for the engaging-disengaging shaft 72. In this case, the engaging-disengaging shaft 72 can be inserted into the gear ring locking portion 611 in the gear ring 61 being rotating, so as to lock up the gear ring 61. The engaging-disengaging shaft 72 is positioned on the engaging segments 705 under the limitation of the second limiting portions 702, so as to realize transmission output between the first planetary gear set 5 and the second planetary gear set 6, and further enable the planetary gear set to convey transmission to the winding drum, thereby making the winch run normally.

After the cable is fixed, if the motor drive assembly 2 continues rotating counterclockwise due to misoperation, the resetting elastic piece 82 can enable the resetting push piece 81 to slip so as to prevent interference of the resetting push piece 81 for the engaging-disengaging toggle sheet 73 during rotation. In this way, it is avoided that the resetting push piece 81 or the engaging-disengaging toggle sheet 73 is broken off. After slipping, the resetting push piece 81 can be reset automatically under the action of the resetting elastic piece 82. But a collision sound between the resetting push piece 81 and the engaging-disengaging toggle sheet 73 can be heard on the winch. Therefore, it is required to stop the motor drive assembly 2 and readjust the motor drive assembly 2 to clockwise rotation.

### Embodiment 2

The embodiment 2 differs from the embodiment 1 only in the structure of the resetting drive component 8, but is identical to the embodiment 1 in other structures and use methods.

In this embodiment, the resetting drive component 8 is only a resetting push piece 81 and the resetting push piece is a resetting pawl plate. The resetting push piece 81 is connected to the planetary gear side plate 62, and a radial outer end of the resetting push piece 81 is exposed beyond the planetary gear side plate 62. The radial outer end of the resetting push piece 81 is in transmission cooperation with the engaging-disengaging toggle sheet 73. Due to no resetting clastic piece 82, the motor drive assembly 2 can only drive the planetary gear side plate 62 to unidirectionally rotate clockwise. During the unidirectional rotation, the resetting push piece 81 abuts against the engaging-disengaging toggle sheet 73 to bring the inner end of the engaging-disengaging shaft 72 to be inserted into the gear ring locking portion 611.

In conclusion, based on the embodiments 1 and 2, the present disclosure has the following advantages: this mechanism conveys transmission to the second planetary gear set 6 through the rotation of the motor drive assembly 2, and the resetting drive component 8 on the second planetary gear set 6 automatically switches back the engaging-disengaging assembly 7 such that the engaging-disengaging shaft 72 on the engaging-disengaging assembly 7 can be automatically inserted into the gear ring locking portion 611 on the gear ring 61 of the second planetary gear set 6. In this case, the second planetary gear set 6 changes from an idle state to a normal running state. Therefore, it is not required to go back to the winch to manually switch back the engaging-disengaging assembly 7, bringing conveniences to use, saving time and labor, and greatly improving the use experiences.

In the descriptions of the embodiments of the present disclosure, it is noted that, in the descriptions of the present disclosure, the terms “inner”, “outer” and the like indicating direction or positional relationship are based on the direction or positional relationship shown in drawings and are used for the purpose of ease of descriptions rather than for indicating or implying the device or member must have a specific orientation or be constructed or operated in a specific orientation and thus these terms shall not be understood as limiting of the present disclosure.

In the descriptions of the present disclosure, the descriptions by referring to the terms “one embodiment”, “some embodiments” “in this embodiment”, “specific example” or “some examples” or the like mean that the specific features, mechanisms, materials or characteristics described in combination with this embodiment or example are incorporated in at least one embodiment or example of the present disclosure. In this specification, the illustrative expressions of the above terms are not necessarily directed to same embodiment or example. Furthermore, the described specific features, mechanisms, materials or characteristics may be combined in an appropriate way in one or more embodiments or examples. Moreover, in a case of no conflicts, those skilled in the arts may perform combination for different embodiments or examples and the features of different embodiments or examples in the specification.

The above descriptions are only about the specific embodiments of the present disclosure but the scope of protection of the present disclosure is not limited hereto. All changes or substitutions those skilled in the arts can easily conceive of within the technical scope of the present disclosure shall fall within the scope of protection of the present disclosure. Therefore, the scope of protection of the present disclosure shall be indicated by the claims.

What is claimed is:

1. An automatic resetting mechanism for a winch engaging-disengaging switch, comprising a winch bracket, a motor drive assembly, a gear box, a drive shaft, a planetary gear set, and an engaging-disengaging assembly; wherein the motor drive assembly and the gear box are respectively disposed at left and right sides of the winch bracket; the planetary gear set is mounted inside the gear box; a first end of the drive shaft is connected with the motor drive assembly, and the motor drive assembly is used to drive a rotation of the drive shaft; a second end of the drive shaft runs through the winch bracket to be in transmission connection with the planetary gear set; at least one gear ring locking portion is disposed circumferentially on an outer circumferential wall of a gear ring of the planetary gear set; the engaging-disengaging assembly comprises an engaging-disengaging seat, an engaging-disengaging shaft, and an engaging-disengaging toggle sheet; the engaging-disengaging seat is fixed on the gear box; a positioning step is disposed on the engaging-disengaging seat; the engaging-disengaging shaft is penetrated into the engaging-disengaging seat along a radial direction of the drive shaft and rotatably connected with the engaging-disengaging seat; an engaging-disengaging pin protruding along a radial direction of the engaging-disengaging shaft is disposed on a sidewall of the engaging-disengaging shaft; the engaging-disengaging pin is abutted against the positioning step; the engaging-disengaging shaft is rotated along a trajectory of the positioning step through the engaging-disengaging pin such that the engaging-disengaging shaft is allowed to be moved axially; in a case of engagement, an inner end of the engaging-disengaging shaft is inserted into the corresponding gear ring locking portion; an elastic connection piece is disposed between the engaging-disengaging shaft and the engaging-disengaging seat, and the elastic connection piece has a tendency of moving the engaging-disengaging shaft radially toward the gear ring; the engaging-disengaging toggle sheet is mounted on the engaging-disengaging shaft; an end of the engaging-disengaging toggle sheet protrudes out of the engaging-disengaging shaft along the radial direction of the engaging-disengaging shaft; a resetting drive component in transmission cooperation with the engaging-disengaging toggle sheet is disposed on a planetary gear side plate of the planetary gear set; the resetting drive component is used to rotate the engaging-disengaging toggle sheet such that the engaging-disengaging shaft is allowed to be slid downward along the positioning step and finally inserted into the corresponding gear ring locking portion by the elastic connection piece.

2. The automatic resetting mechanism for the winch engaging-disengaging switch of claim 1, wherein the resetting drive component comprises a resetting push piece connected to the planetary gear side plate, and the resetting push piece is in transmission cooperation with the engaging-disengaging toggle sheet.

3. The automatic resetting mechanism for the winch engaging-disengaging switch of claim 1, wherein the resetting drive component comprises a resetting push piece and a resetting elastic piece; the resetting push piece is rotatably connected on the planetary gear side plate; a radial inner end of the resetting push piece is connected with a first end of the resetting elastic piece, and a second end of the resetting elastic piece is fixedly connected on the planetary gear side plate; a radial outer end of the resetting push piece is in transmission cooperation with the engaging-disengaging toggle sheet; the resetting elastic piece is configured to rotationally reset the resetting push piece in slipping during a reverse rotation; in the case of engagement, the resetting push piece is configured to rotate along with the planetary gear side plate to abut against the engaging-disengaging toggle sheet, to realize a synchronous movement of the engaging-disengaging toggle sheet and the engaging-disengaging shaft, and make the engaging-disengaging shaft in insertion cooperation with the gear ring locking portion.

4. The automatic resetting mechanism for the winch engaging-disengaging switch of claim 3, wherein a limiting column is disposed on the planetary gear side plate and located at a radial inner side of the resetting push piece; a limiting recess in limiting cooperation with the limiting column is disposed on the resetting push piece to achieve a rotational limitation for the resetting push piece.

5. The automatic resetting mechanism for the winch engaging-disengaging switch of claim 1, wherein a gear ring positioning sleeve is mounted inside the gear box; a gear ring positioning annular groove is disposed circumferentially on an inner circumferential wall of the gear ring positioning sleeve; the gear ring is rotatably connected inside the gear ring positioning annular groove and positioned along an axial direction of the drive shaft inside the gear ring positioning annular groove; a penetration insertion hole for the inner end of the engaging-disengaging shaft to penetrate through is disposed at the engaging-disengaging shaft on the gear ring positioning sleeve; and an active opening for a rotation of the engaging-disengaging toggle sheet is disposed at a side of the penetration insertion hole adjacent to the resetting drive component.

6. The automatic resetting mechanism for the winch engaging-disengaging switch of claim 1, wherein a first limiting portion and a second limiting portion for limiting the engaging-disengaging pin from sliding are respectively disposed at both ends of the positioning step; the positioning step comprises a horizontal disengaging segment and a horizontal engaging segment, wherein the horizontal disengaging segment and the horizontal engaging segment are from shallow to deep; in a case of disengagement, the engaging-disengaging pin is located in the horizontal disengaging segment and limitedly abutted against the first limiting portion to make the engaging-disengaging shaft disengage from the gear ring locking portion; in the case of engagement, the engaging-disengaging pin is located in the horizontal engaging segment and limitedly abutted against the second limiting portion such that the engaging-disengaging shaft insert into and abut in the gear ring locking portion.

7. The automatic resetting mechanism for the winch engaging-disengaging switch of claim 1, wherein an inwardly-recessed first step is disposed inside the engaging-disengaging seat; an inwardly-recessed second step is disposed on the engaging-disengaging shaft inside the engaging-disengaging seat; the elastic connection piece is sleeved on the inwardly-recessed second step; a first end of the elastic connection piece is abutted against a first step surface of the inwardly-recessed first step, and a second end of the elastic connection piece is abutted against a second step surface of the inwardly-recessed second step.

8. The automatic resetting mechanism for the winch engaging-disengaging switch of claim 1, wherein the inner end of the engaging-disengaging shaft penetrates through the engaging-disengaging seat and is integrally provided with an inwardly-recessed engaging-disengaging shaft fixing segment; a fixing step is formed between the inwardly-recessed engaging-disengaging shaft fixing segment and the inner end of the engaging-disengaging shaft; an annular clamping groove is disposed on the inwardly-recessed engaging-disengaging shaft fixing segment, and a circlip is disposed in the annular clamping groove; the engaging-disengaging toggle sheet is sleeved on the inwardly-recessed engaging-disengaging shaft fixing segment, and the engaging-disengaging toggle sheet is limited between the fixing step and the circlip.

9. The automatic resetting mechanism for the winch engaging-disengaging switch of claim 8, wherein an insertion shaft segment is integrally disposed on an inner end of the inwardly-recessed engaging-disengaging shaft fixing segment; an inwardly-recessed insertion step is formed between the insertion shaft segment and the inner end of the engaging-disengaging shaft; in a case of locking, the insertion shaft segment is inserted into the gear ring locking portion, and an insertion step surface of the inwardly-recessed insertion step is abutted against the outer circumferential wall of the gear ring.

10. The automatic resetting mechanism for the winch engaging-disengaging switch of claim 1, wherein an engaging-disengaging switching handle is fixedly connected at an outer end of the engaging-disengaging shaft, and the engaging-disengaging switching handle is located outside the gear box.
